(19) United States
(12) Patent Application Publication
(10) Pub. No.: US 2026/0277492 A1
(43) Pub. Date: Sep. 17, 2026

(54) VOLUME MOUNTING AND ACCESS METHOD, DEVICE, AND STORAGE MEDIUM

(71) Applicant: CLOUD INTELLIGENCE ASSETS HOLDING (SINGAPORE) PRIVATE LIMITED, Singapore (SG)

(72) Inventors: Lei WANG, Hangzhou, Zhejiang (CN); Leilei TIAN, Hangzhou, Zhejiang (CN); Xu JI, Hangzhou, Zhejiang (CN); Li XU, Hangzhou, Zhejiang (CN)

(21) Appl. No.: 19/471,578

(22) PCT Filed: Apr. 2, 2024
(86) PCT No.: PCT/CN2024/085588

§ 371 Date: Oct. 1, 2025

(30) Foreign Application Priority Data
Apr. 3, 2023 (CN) 202310369529.X

(51) Int. Cl. G06F 3/06

(52) U.S. Cl. CPC G06F 3/0665; G06F 3/0608; G06F 3/0631; G06F 3/067

(57) ABSTRACT

Embodiments of the present application provide a volume mounting and access method, a device, and a storage medium. In the embodiments, for a volume that is bound to an application instance, the volume is mounted to a host machine directory tree in a sub-tree mounting manner. That is, the host machine directory tree includes a root mount point of the volume and a child mount point that points to the root mount point, so that the application instance can access the volume through the root mount point on the host machine directory tree, thereby achieving the purpose of using, by means of the volume, a storage system of the host machine as a storage facility for realizing data sharing and persistence of the application instance. Further, the plurality of application instances all access the volume by using the root mount point, thereby saving memory resources of the host machine.

### CROSS-REFERENCE TO RELATED APPLICATIONS

This application is a national stage of International Application No. PCT/CN2024/085588, filed on Apr. 2, 2024, which claims priority to Chinese Patent Application No. CN202310369529.X, filed with the China National Intellectual Property Administration on Apr. 3, 2023 and entitled “VOLUME MOUNTING AND ACCESS METHOD, DEVICE, AND STORAGE MEDIUM”. Both of the aforementioned applications are incorporated herein by reference in their entireties.

### TECHNICAL FIELD

The present application relates to the field of cloud storage technologies, and in particular, to a volume mounting and access method, a device, and a storage medium.

### BACKGROUND

In a cloud computing scenario, the containerization application deployment form has become a mainstream application deployment form, and is also an important component of Cloud Native computing transformation. Containerization reconstruction is gradually performed on a large quantity of applications. To implement persistent storage of data in a containerization application, a concept of a volume is provided. This provides a basis for a containerization application to use a storage system of a host machine as a storage facility of the containerization application for data sharing and persistence. Therefore, how to enable, by using a volume, a containerization application to use a storage system of a host machine as a storage facility of the containerization application for data sharing and persistence is a significant technical problem faced in the cloud computing field.

### SUMMARY

Various aspects of the present application provide a volume mounting and access method, a device, and a storage medium, to mount a volume to a host machine directory tree in a sub-tree mounting manner, so that an application instance can use, by means of the volume, a storage system of a host machine as a storage facility for data sharing and persistence.

An embodiment of the present application provides a volume mounting method, including: determining a target volume that is bound to a target application instance and that is to be mounted to a host machine directory tree, where the host machine directory tree is a directory tree of a host machine where the target application instance is located; if the host machine directory tree includes a root mount point of the target volume, creating a child mount point that points to the root mount point on the host machine directory tree for the target application instance; and mounting the target volume to the root mount point in a sub-tree mounting manner based on the child mount point, so that the target application instance accesses the target volume through the root mount point.

An embodiment of the present application further provides a volume access method, including: in response to an access operation of a target application instance on a target volume, where the target volume is a volume that is bound to the target application instance and that is mounted to a host machine directory tree; generating an access path of the target volume according to a root mount point and a child mount point of the target volume on the host machine directory tree; and performing an access operation of a corresponding type on the target volume according to the access path.

An embodiment of the present application further provides a computing device, including: a memory and a processor, the memory being configured to store a computer program; the processor being coupled to the memory and configured to execute the computer program to perform the steps in the volume mounting method and/or the volume access method provided in the embodiments of the present application.

An embodiment of the present application further provides a computer readable storage medium storing a computer program. The computer program, when executed by a processor, causes the processor to implement the steps in the volume mounting method and/or the volume access method provided in the embodiments of the present application.

In the embodiments of the present application, for a volume that is bound to an application instance, the volume is mounted to a host machine directory tree in a sub-tree mounting manner. That is, the host machine directory tree includes a root mount point of the volume and a child mount point that points to the root mount point, so that the application instance can access the volume through the root mount point on the host machine directory tree, thereby achieving the purpose of using, by means of the volume, a storage system of the host machine as a storage facility for realizing data sharing and persistence of the application instance.

Further, in the manner of mounting the volume by using a sub-tree, when the volume is bound to a plurality of application instances, all of the application instances access the volume by using the root mount point, so that a same cache space can be shared, thereby saving memory resources of the host machine.

Further, the sub-tree mounting manner pertains to a mounting operation natively supported by an operating system of the host machine, and can maintain the same logic and user experience as those of independent mount in aspects of information statistics collection and mounting permission control at a system level.

### BRIEF DESCRIPTION OF DRAWINGS

The accompanying drawings described herein are used to provide a further understanding of the present application, and form part of the present application. Exemplary embodiments of the present application and descriptions thereof are used to explain the present application, and do not constitute any inappropriate limitation to the present application. In the accompanying drawings:

FIG. 1 is a flowchart of a volume mounting method according to an embodiment of the present application.

FIG. 2 is a flowchart of another volume mounting method according to an embodiment of the present application.

FIG. 3 is a flowchart of a volume access method according to an embodiment of the present application.

FIG. 4 is a flowchart of another volume access method according to an embodiment of the present application.

FIG. 5 is a schematic diagram of a scenario of mounting a PV in a K8s cluster according to an embodiment of the present application.

FIG. 6 is a schematic structural diagram of a volume mounting apparatus according to an embodiment of the present application.

FIG. 7 is a schematic structural diagram of a volume access apparatus according to an embodiment of the present application.

FIG. 8 is a schematic structural diagram of a computer device according to an embodiment of the present application.

### DETAILED DESCRIPTION

To clearly states the objectives, technical solutions, and advantages of the present application, the technical solutions of the present application will be clearly and completely described below with reference to specific embodiments of the present application and the accompanying drawings. Apparently, the described embodiments are only some embodiments rather than all the embodiments of the present application. All other embodiments obtained by a person of ordinary skill in the art based on the embodiments of the present application without paying creative efforts shall fall within the protection scope of the present application.

In the embodiments of the present application, “at least one” refers to one or more, and “a plurality of” refers to two or more. “And/or” describing an access relationship between associated objects denotes that there can be three relationships. For example, A and/or B can denote: the following three situations: Only A exists, both A and B exist, and only B exists, where A and B may be single-digit numbers or double-digit numbers. In the literal description of the present application, the character “/” generally indicates an “or” relationship between the associated objects. In addition, in the embodiments of the present application, “first”, “second”, “third”, and the like are merely used for distinguishing content of different objects, and have no other special meanings such as an order or a quantity.

Terms involved in the embodiments of the present application are explained below.

Kubernetes (K8s for short) cluster: An open-source container orchestration and management platform for automatically deploying, extending, and managing a containerization application.

Application instance: A smallest unit on which an application program (briefly referred to as an application) runs in a cloud computing environment. An application is typically run in one or more application instances, the application may have a plurality of deployment versions, and different versions of application programs may run in different application instances. An instance specification of the application instance may be defined, for example, by using the number of central processing unit (CPU) cores and/or a memory capacity. For example, an instance specification is an 8-core CPU and a 8 GB (Gigabyte) memory. Another instance specification is a 4-core CPU and a 4 GB (Gigabyte) memory.

Host machine directory tree: an operating system-level directory tree of a host machine. This embodiment does not limit an operating system used by the host machine, for example, including, but is not limited to: Linux or Unix. For example, for a directory tree of a Linux operating system, everything is a file in Linux. All files in the Linux operating system are stored in a file system, and they are organized into an inverted directory tree. The directory tree is also referred to as a file system hierarchical structure. The tree is inverted because a tree root is located at the top of the hierarchical structure, and a directory and branches of child directories extend below the tree root. A Linux root directory (/) includes many child directories (referred to as first-level directories), and each first-level directory further includes many child directories (referred to as second-level directories).

A volume is an abstract concept of a storage system used by a host machine, such as a local file storage system or a distributed file storage system. A core of the volume is a directory, which may store data, and the application instance may access data in the directory. A type of the volume includes, but is not limited to: a temporary volume used for data buffering or temporary storage, and a network file system (NFS).

A persistent volume (PV) is abstraction of a storage resource in a K8s cluster, and is a specific implementation of the volume. A PV is a storage resource that is defined in a K8s cluster and that can be used by a containerization application. The PV is created and configured by an administrator, is managed by using a plug-in mechanism, and is accessed and used by a pod.

Pod: A set of containers in a running state on a K8s cluster is a specific implementation of the application instance.

Mount point: To access a file in a particular volume, the file needs to be associated with a directory in a host machine directory tree for implementation. This association operation is mount. The directory is a mount point, that is, the mount point is a location of the file in the directory tree.

In a cloud computing scenario, how to enable, by using a volume, a containerization application to use a storage system of a host machine as a storage facility of the containerization application for data sharing and persistence is a great technical problem faced in the cloud computing field. In view of this, embodiments of the present application provide a volume mounting and access method, a device, and a storage medium. In the embodiments of the present application, for a volume that is bound to an application instance, the volume is mounted to a host machine directory tree in a sub-tree mounting manner. That is, the host machine directory tree includes a root mount point of the volume and a child mount point that points to the root mount point, so that the application instance can access the volume through the root mount point on the host machine directory tree, so that the application instance can use, by means of the volume, a storage system of the host machine as a storage facility for realizing data sharing and persistence of the application instance.

Further, in the manner of mounting the volume by using a sub-tree, when the volume is bound to a plurality of application instances, the plurality of application instances all access the volume by using the root mount point, so that a same cache space can be shared, thereby saving memory resources of the host machine.

Further, the sub-tree mounting manner pertains to a mounting operation natively supported by an operating system of the host machine, and can maintain logic and user experience the same as those of independent mount in aspects of information statistics collection and mounting permission control at a system level. For example, when a same volume is bound to a plurality of application instances, not only some application instances can be supported to mount the volume in a read-write manner, but also some application instances can be supported to mount the volume in a read-only manner. Still for example, the operating system can sense each time of mounting of a same volume in the host machine directory tree, thereby facilitating management and maintenance of mounting of the volume.

The following describes the technical solution provided in each embodiment of the present application in detail with reference to the accompanying drawings.

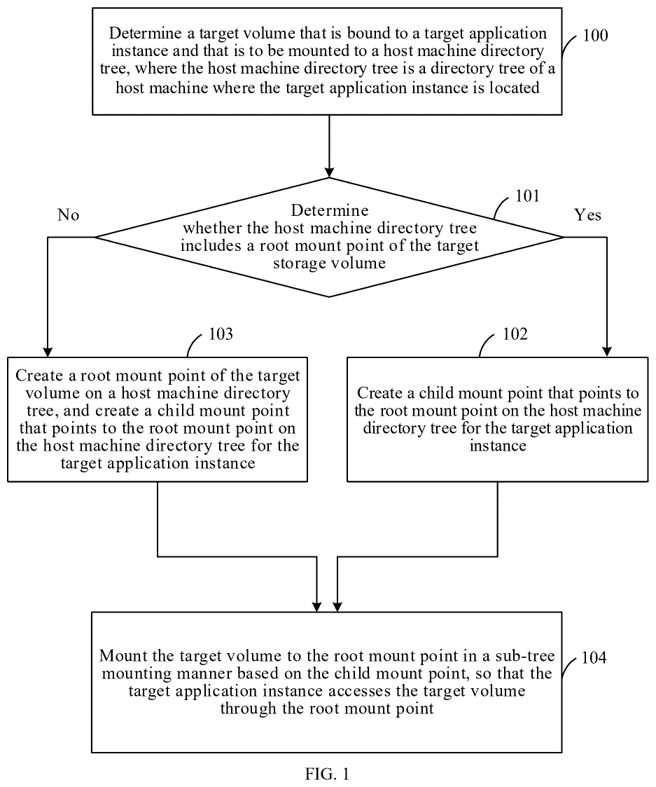

FIG. 1 is a flowchart of a volume mounting method according to an embodiment of the present application. Referring to FIG. 1, the method may include the following steps:
100: Determine a target volume that is bound to a target application instance and that is to be mounted to a host machine directory tree, where the host machine directory tree is a directory tree of a host machine where the target application instance is located.
101: Determine whether the host machine directory tree includes a root mount point of the target volume; if a determining result is yes, that is, the host machine directory tree includes the root mount point of the target volume, perform step 102; and if a determining result is no, that is, the host machine directory tree does not include the root mount point of the target volume, perform step 103.
102: Create a child mount point that points to the root mount point on the host machine directory tree for the target application instance, and perform step 104.
103. Create a root mount point of the target volume on a host machine directory tree, and create a child mount point that points to the root mount point on the host machine directory tree for the target application instance, and perform step 104.
104: Mount the target volume to the root mount point in a sub-tree mounting manner based on the child mount point, so that the target application instance accesses the target volume through the root mount point.

In this embodiment, the target application instance is carried on a host machine, the host machine may carry one or more application instances, and the target application instance may be any application instance carried on the host machine. Further, the target application instance in this embodiment may be a containerization application instance, for example, may be a container or a pod. In view of the function implemented by the target application instance, the target application instance may be, but is not limited to: a load balancing instance, a database instance, a cloud server instance, and the like. The host machine may be any computer device in a broad sense that can carry the target application instance, for example, may be a terminal device such as a laptop or a mobile phone, or may be a server device such as a conventional server, a cloud server, or a server cluster. In this embodiment, the host machine is mounted with a physical storage system, for example, a block storage device, a magnetic disk, or a Network Attached Storage (NAS), and manages the physical storage system by using a host machine directory tree. The host machine directory tree is a directory tree used on the host machine to manage the physical storage system of the host machine. Further, the NAS may include an NFS (Network File System).

In this embodiment, to facilitate sharing and persistence of data generated by the application instance, a concept of a volume is used. The volume is storage space defined on a physical storage system mounted on a host machine. The volume is independent of a life cycle of the application instance, and therefore, the data stored in the volume may continue to be used after the application instance is restarted or reestablished. In this embodiment, an implementation of the volume is not limited. For example, the volume may be, but is not limited to, a PV. A user may declare in advance a volume or volumes that needs to be bound to the target application instance as required. According to the advanced declaration of the user, one or more volumes may be bound for the target application instance. Any volume may be bound to one or more application instances on the host machine. For ease of description, any volume bound to the target application instance is referred to as a target volume, and for example, a volume mounting process provided in the embodiments of the present application is described by using the target volume. To facilitate the target application instance in using, by means of the volume, the physical storage system of the host machine as a storage facility for data sharing and persistence, the target volume bound to the target application instance may be mounted to a host machine directory tree (which may be referred to as mounting the target volume for short), that is, an association relationship is established between the volume and a directory on the host machine directory tree. In this way, when the target application instance writes data into the target volume, the data is written into a corresponding directory of the physical storage system on the host machine that establishes the association relationship with the target volume, thereby implementing persistent storage of the data. Further, when another application instance and the target application instance are bound to a same target volume, data sharing may alternatively be implemented between the another application instance and the target application instance.

In this embodiment, when the target volume is mounted, different from a conventional volume mounting manner, the target volume is mounted to the host machine directory tree in a sub-tree mounting manner instead of using an independent mounting manner or a root directory mounting manner.

The independent mounting manner refers to that for a same volume, in a case that the volume is bound to different application instances, the volume is mounted independently for the different application instances. From the perspective of the operating system of the host machine, mounting of the same volume by the different application instances forms an independent directory tree, and the directory trees are completely isolated from each other and do not share any resource. In the independent mounting manner, for different application instances, cached data of a same volume needs to be stored for a plurality of pieces, which may waste cache resources of the host machine.

The root directory mounting manner refers to that for a same volume, when the volume is mounted to the root directory of the host machine directory tree for the first time, the unique mount point is directly reused in a link-to-point manner for another application instance subsequently bound to the volume. In the root directory mounting manner, because different application instances reuse the same mount point, different application instances can only use a same mounting permission, or read-only, or read-write, which is not flexible enough in terms of mounting permission control. In addition, from the perspective of the operating system of the host machine, this manner is equivalent to mounting the volume only once. Therefore, the operating system cannot learn of mounting information of the volume for different application instances, causing inconvenience to management and maintenance of the volume.

The sub-tree mounting manner used in the embodiments refers to that for a same volume, the target volume is used as an example, a root mount point is created on the host machine directory tree for the target volume, and in addition, for different application instances bound to the target volume, child mount points that point to the root mount point are separately created on the host machine directory tree for the target volume, so as to access the target volume through the root mount point. In the sub-tree mounting manner, one root mount point of the target volume and at least one child mount point that points to the root mount point appear on the host machine directory tree. The root mount point and the at least one child mount point form a mounting directory tree corresponding to the target volume, and resource allocation and management are performed for the target volume at the granularity of the mounting directory tree. A quantity of the child mount points is determined according to a quantity of the application instances to which the target volume is bound.

In the sub-tree mounting manner, for different application instances, the root mount point needs to be used when the target volume is accessed. An association relationship can be established between different application instances bound to the same target volume by using the root mount point, to implement resource sharing. Cached data of the target volume only needs to be stored for one piece, which is beneficial to saving cache resources of the host machine. In addition, different application instances bound to a same target volume have their respective child mount points instead of completely reusing a same mount point, and the different application instances are allowed to use different mounting permissions for mounting. That is, some application instances are allowed to mount the target volume in a read-only manner, and some application instances are allowed to mount the target volume in a read-write manner. This is highly flexible in terms of mounting permission control.

In this embodiment, a mounting occasion for mounting the target volume is not limited, and may be any occasion before the target application instance accesses the target volume. A master for managing the application instances exists in a cluster where the host machine is located. The master may monitor information such as whether a new application instance is created in a computing cluster and whether the application instance is bound to a volume, to be responsible for scheduling the application instance to a computing node in the cluster. The computing node to which the application instance is scheduled is the host machine carrying the application instance. In this scenario, the master may further send a mounting instruction to the host machine carrying the application instance, to instruct the host machine to perform a mounting operation on the volume bound to the application instance. Based on the foregoing description, the mounting occasion of mounting the target volume to the host machine directory tree includes, but is not limited to, the following cases:

For example, the mounting operation of mounting the target volume may be performed when a mounting instruction sent by the master is received, the master is in a same computing cluster as the host machine and has a management function. The mounting instruction instructs the host machine to perform the mounting operation on the target volume bound to the target application instance.

Still for example, when it is monitored that the target application instance is scheduled to the host machine, the host machine directory tree is automatically established and persisted for the target application instance, and the mounting operation of mounting the target volume is performed. Persistence of the host machine directory tree refers to a process of associating the host machine directory tree with the physical storage system.

Still for example, when it is monitored that the target application instance is created on the host machine, but the target volume bound to the target application instance is not mounted to the host machine directory tree, the mounting operation of mounting the target volume is performed.

Still for example, when the target application instance initiates a data access request to the target volume, if it is found that the target volume is not mounted to the host machine directory tree, the mounting operation of mounting the target volume is performed.

In this embodiment, when the target volume is mounted to the host machine directory tree, a mounting command supported by an operating system of the host machine may be invoked, and the operating system of the host machine performs the mounting operation, but the present application is not limited thereto. For example, a volume mounting process may alternatively be deployed on the host machine, and the volume mounting process performs the volume mounting operation provided in this embodiment. Regardless of whether an execution body is the operating system or the volume mounting process, when a mounting operation is performed, whether the host machine directory tree includes the root mount point of the target volume is first determined. The target volume is associated on the host machine directory tree with a directory unrelated to the application instance bound to the target volume, and the directory is referred to as a root mount point of the target volume on the host machine directory tree. The directory used as the root mount point may be declared, specified, or configured by a user in advance.

In this embodiment, to quickly and accurately determine whether the host machine directory tree includes the root mount point of the target volume, a mount list may be maintained for the host machine directory tree, and a volume identifier of the volume mounted to the host machine directory tree and the root mount point of the volume are associatively recorded in the mount list. That is, the mount list records a mapping relationship between the volume already mounted to the host machine directory tree and the root mount point. Therefore, when determining whether the host machine directory tree includes the root mount point of the target volume, matching may be performed in the mount list corresponding to the host machine directory tree according to an identifier of the target volume; if the identifier of the target volume is found through matching, the root mount point corresponding to the identifier of the target volume is used as the root mount point of the target volume; and if the identifier of the target volume is not found through matching, it is determined that the host machine directory tree does not include the root mount point of the target volume.

In this embodiment, for each mounting of the target volume, a child mount point may be created on the host machine directory tree for the target volume. The child mount point is a child node of the root mount point, and the root mount point is a parent node of the child mount point, thereby mounting the target volume to the root mount point in a sub-tree mounting manner. During actual application, the target volume may be bound to one or more application instances. When the target volume is bound to one application instance, one root mount point of the target volume and one child mount point that points to the root mount point appear on the host machine directory tree. In this case, the target volume corresponds to one mounting directory tree having one child mount point. As time goes by, when the target volume is bound to a plurality of application instances, one root mount point of the target volume and a plurality of child mount points that point to the root mount point appear on the host machine directory tree. In this case, the target volume corresponds to one mounting directory tree having a plurality of child mount points.

Based on the above, if the host machine directory tree includes a root mount point of the target volume, a child mount point that points to the root mount point is created on the host machine directory tree for the target application instance; and then, the target volume is mounted to the root mount point in a sub-tree mounting manner based on the child mount point, so that the target application instance accesses the target volume through the root mount point. If the host machine directory tree does not include the root mount point of the target volume, before creating the child mount point, the root mount point of the target volume is created on the host machine directory tree; next, a child mount point that points to the root mount point is created on the host machine directory tree for the target application instance; and then, the target volume is mounted to the root mount point in a sub-tree mounting manner based on the child mount point, so that the target application instance accesses the target volume through the root mount point.

In is embodiment, a user may preconfigure the directory location of the target application instance on the host machine directory tree by using a configuration file. Based on this, when the child mount point that points to the root mount point is created on the host machine directory tree for the target application instance, the corresponding directory location of the target application instance on the host machine directory tree may be obtained from the configuration file corresponding to the target application instance; the directory location is used as a child mount point, and a pointing relationship between the child mount point and the root mount point is established. For example, when the pointing relationship between the child mount point and the root mount point is established, the root mount point may be used as a parent mount point of the child mount point, and the identifier of the root mount point is recorded in attribute information of the child mount point.

In this embodiment, the child mount point may be understood as a lower-level directory of the root mount point, and the root mount point may be understood as an upper-level directory of the child mount point. A pointing relationship exists between the child mount point and the root mount point. That is, the child mount point is bound to the root mount point. When a pointing relationship does not exist between the child mount point and the root mount point, the child mount point is unbound from the root mount point.

In this embodiment, to facilitate maintenance and management of the mounting operation of the volume, after the target volume is mounted to the root mount point in a sub-tree mounting manner based on the child mount point, the quantity of cited times of the root mount point may further be increased according to a set quantity-of-times update step size, where the quantity-of-times update step size is a positive integer. The quantity-of-times update step size is flexibly set according to an actual application requirement, for example, 1, 2, or 3. The quantity of cited times of the root mount point reflects a quantity of mounting times of the target volume. For example, the quantity-of-times update step size is 1, each time the target volume is mounted, a corresponding quantity of cited times of the root mount point is increased by 1.

In this embodiment, to facilitate maintenance and management of the mounting operation of the volume, when the target application instance is destructed from the host machine, the quantity of cited times of the root mount point may further be reduced according to the quantity-of-times update step size; and in a case that the quantity of cited times of the root mount point is a preset initial value, the root mount point is uninstalled from the host machine directory tree.

Specifically, when the target application instance is destructed from the host machine, the corresponding child mount point is correspondingly destructed, that is, the corresponding child mount point is deleted from the host machine directory tree, and the corresponding child mount point is unbound from the root mount point. In addition, when the target application instance is destructed from the host machine, the quantity of cited times of the root mount point further needs to be reduced according to the quantity-of-times update step size. For example, the quantity-of-times update step size is 1. When the target application instance is destructed, the quantity of cited times of the corresponding root mount point is reduced by 1, and as application instances bound to the target volume are continuously destructed, the quantity of cited times of the root mount point is continuously reduced until reaching a preset initial value. If the quantity of cited times of the root mount point is reduced to the preset initial value, the root mount point is uninstalled from the host machine directory tree, that is, the root mount point of the target volume does not exist on the host machine directory tree any more. The preset initial value is flexibly set as required, for example, is 0, 1, or 2.

In the embodiments of the present application, for a volume that is bound to an application instance, the volume is mounted to a host machine directory tree in a sub-tree mounting manner. That is, the host machine directory tree includes a root mount point of the volume and a child mount point that points to the root mount point, so that the application instance can access the volume through the root mount point on the host machine directory tree, thereby achieving the purpose of using, by means of the volume, a storage system of the host machine as a storage facility for realizing data sharing and persistence of the application instance.

Further, in the manner of mounting the volume by using a sub-tree, when the volume is bound to a plurality of application instances, the plurality of application instances all access the volume by using the root mount point, and the plurality of application instances can share a same cache space with each other by using the root mount point, thereby saving memory resources of the host machine.

Further, the sub-tree mounting manner pertains to a mounting operation natively supported by an operating system of the host machine, and can maintain logic and user experience the same as those of independent mount in aspects of information statistics collection and mounting permission control at a system level. For example, mounting permission control such as read-write and read-only can be continuously supported. When a same volume is bound to a plurality of application instances, not only some application instances are supported to mount the volume in a read-write manner, but also some application instances are supported to mount the volume in a read-only manner. Still for example, based on creation of the child mount point, the operating system may sense each time of mounting of a same volume in the host machine directory tree, which facilitates management and maintenance of the mounting of the volume, so as to collect statistics on system-level information for the volume, and have a better user experience.

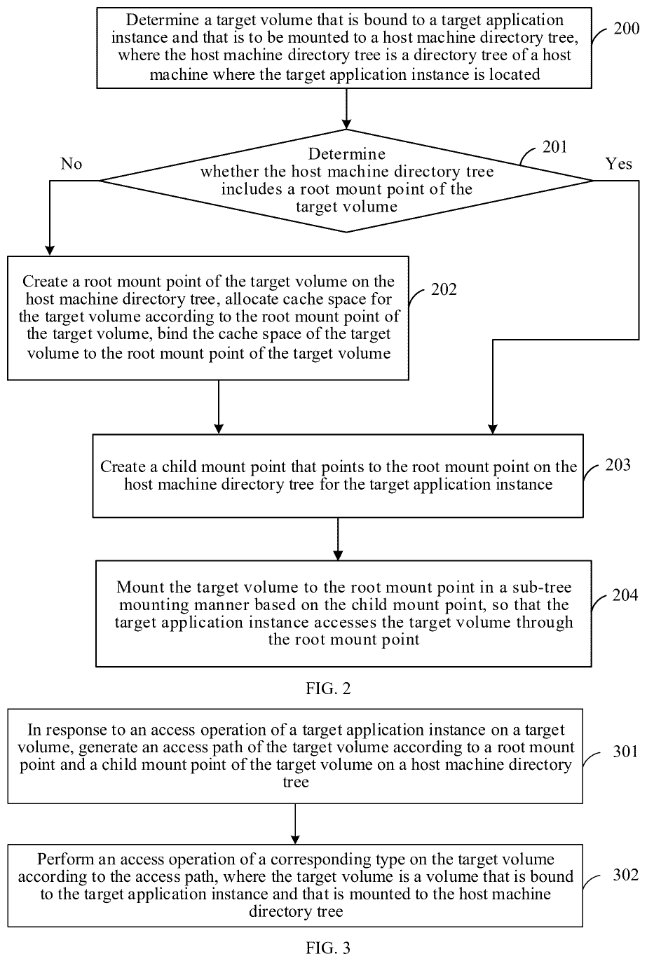

FIG. 2 is a flowchart of another volume mounting method according to an embodiment of the present application. Referring to FIG. 2, the method may include the following steps:
200: Determine a target volume that is bound to a target application instance and that is to be mounted to a host machine directory tree, where the host machine directory tree is a directory tree of a host machine where the target application instance is located.
201: Determine whether the host machine directory tree includes a root mount point of the target volume; if a determining result is no, that is, the host machine directory tree does not include the root mount point of the target volume, perform steps 202, 203, and 204. If a determining result is yes, that is, the host machine directory tree includes the root mount point of the target volume, perform steps 203 and 204.
202: Create a root mount point of the target volume on the host machine directory tree, allocate cache space for the target volume according to the root mount point of the target volume, bind the cache space of the target volume to the root mount point of the target volume, and perform step 203.
203: Create a child mount point that points to the root mount point on the host machine directory tree for the target application instance, and perform step 204.
204: Mount the target volume to the root mount point in a sub-tree mounting manner based on the child mount point, so that the target application instance preferentially accesses the cache space of the target volume through the root mount point.

For implementations of step 200, step 201, step 203, and step 204 in this embodiment, refer to related descriptions in the foregoing embodiments, and details are not described herein again.

In this embodiment, when the root mount point is created for the target volume, the cache space may further be allocated for the target volume based on the root mount point, and the cache space of the target volume is bound to the root mount point of the target volume. The cache space is configured to store cached data corresponding to the target volume, for example, data, metadata, and a directory item in the target volume. It is to be noted that, the cached data dynamically changes according to an access state of the target volume. In this embodiment of the present application, cache resources are allocated for the target volume at the granularity of the mounting directory tree, so that all of the application instances bound to the target volume can share the cache space by using the pointing relationship between the child mount point and the root mount point, and cached data does not need to be maintained for each application instance, thereby facilitating saving cache resources for the host machine.

After the target volume is mounted to the host machine directory tree, the target application instance bound to the target volume may access the target volume through the host machine directory tree. Based on mounting the target volume to the host machine directory tree in a sub-tree mounting manner, an embodiment of the present application further provides a volume access method.

FIG. 3 is a flowchart of a volume access method according to an embodiment of the present application. Referring to FIG. 3, the method may include the following steps:
301: In response to an access operation of a target application instance on a target volume, generate an access path of the target volume according to a root mount point and a child mount point of the target volume on a host machine directory tree.
302: Perform an access operation of a corresponding type on the target volume according to the access path, where the target volume is a volume that is bound to the target application instance and that is mounted to the host machine directory tree.

In this embodiment, the target volume is a volume bound to the target application instance and mounted to the host machine directory tree, and the target volume is mounted to the host machine directory tree in a sub-tree mounting manner. For related descriptions of the mounting process, refer to the foregoing embodiments, and details are not described herein again.

After the target volume is mounted to the host machine directory tree, the target application instance may initiate an access operation on the target volume. For example, the access operation includes, but is not limited to: opening a file in the target volume, reading/writing a file in the target volume, closing a file in the target volume, and the like. The target application instance may initiate an access operation on the target volume by using a portable operating system interface (POSIX), but this is not limited thereto. The access operation on the target volume may be performed by the operating system of the host machine, and this is not limited herein.

After the target application instance initiates the access operation on the target volume, the host machine directory tree may be queried to determine a root mount point and a child mount point of the target volume on the host machine directory tree. The child mount point herein is a child mount point of the target volume on the host machine directory tree for the target application instance, and the access operation is initiated by the target application instance. Next, an access path of the target volume is generated according to the root mount point and the child mount point of the target volume on the host machine directory tree; and an access operation of a corresponding type is performed on the target volume according to the access path. A type of the access operation includes, but is not limited to: opening, reading/writing, closing a file, and the like. It is to be noted that, with execution of the access operation, metadata such as a latest access time of an accessed file and an access object may change.

In this embodiment, the child mount point may be understood as a lower-level directory of the root mount point, and the root mount point may be understood as an upper-level directory of the child mount point. When the access path of the target volume is generated according to the root mount point and the child mount point of the target volume on the host machine directory tree, a main access path may be generated according to the root mount point, and a sub-access path may be generated according to the child mount point. Then, the main access path and the sub-access path are spliced based on the pointing relationship existing between the child mount point and the root mount point, to obtain an access path of the target volume.

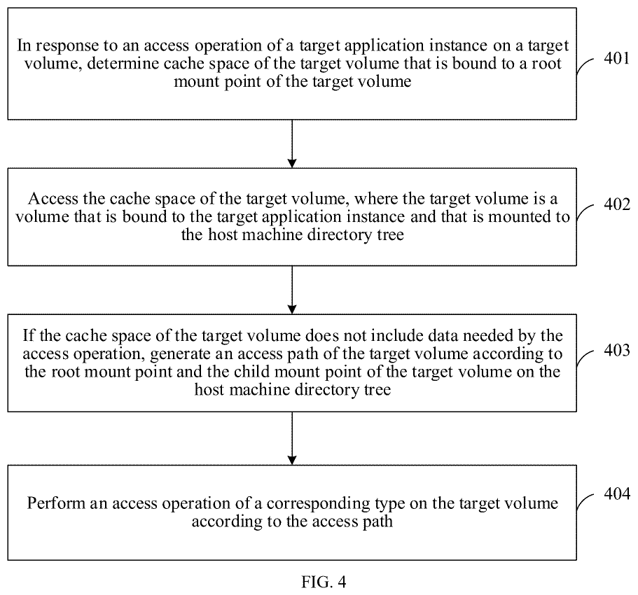

FIG. 4 is a flowchart of another volume access method according to an embodiment of the present application. Referring to FIG. 4, the method may include the following steps:
401: In response to an access operation of a target application instance on a target volume, determine cache space of the target volume that is bound to a root mount point of the target volume.
402: Access the cache space of the target volume, where the target volume is a volume that is bound to the target application instance and that is mounted to the host machine directory tree.
403: If the cache space of the target volume does not include data needed by the access operation, generate an access path of the target volume according to the root mount point and the child mount point of the target volume on the host machine directory tree.
404: Perform an access operation of a corresponding type on the target volume according to the access path.

In this embodiment, after the target application instance initiates the access operation on the target volume, the cache space of the target volume may be accessed preferentially, and in a case that the cache space of the target volume does not include data needed by the access operation, the access path of the target volume is generated according to the root mount point and the child mount point of the target volume on the host machine directory tree, and the target volume is accessed according to the access path. Further, in a case that the data needed by the access operation exists in the cache space of the target volume, local cache space of the host machine may be directly accessed without accessing a remote physical storage system, so that the data access speed and efficiency are increased. In addition, for descriptions of other steps in this embodiment, refer to the foregoing embodiments, and details are not described herein again.

In the technical solutions provided in the embodiments of the present application, the volume bound to the application instances is mounted to the host machine directory tree in the sub-tree mounting manner, and the cache space of the target volume is bound to the root mount point of the target volume, so that the plurality of application instances may share the cache space of the target volume, and it is unnecessary to configure a plurality of cache spaces for a same volume, thereby saving cache resources of the host machine. In this way, when the application instance initiates the access operation on the volume, the application instance may preferentially access the cache space of the target volume, and access the target volume in a case that the cache space of the target volume does not include the data needed by the access operation, so that the data access efficiency and speed are increased.

To better understand the technical solutions provided in the embodiments of the present application, for example, the following describes the technical solutions provided in the embodiments of the present application in detail by using a K8s (abbreviation of Kubernetes) cluster scenario.

In a K8s cluster, a PV concept is provided, a Pod is allowed to be bound to a PV, and a plurality of pods are allowed to be bound to a same PV. The PV is mounted to a directory tree of a host machine, so that the pods can implement data sharing and persistent storage by using a storage system of the host machine. In a conventional solution, mounting by each pod to the PV is independent. From the perspective of the operating system of the host machine, each mounting is an independent directory tree. These directory trees are completely isolated and do not share any resource. In this independent mounting manner, when different pods are bound to a same PV, cache resources of the different pods for the same PV are not shared, and cache data of one PV needs to be maintained for the different pods. This wastes the cache resources of the host machine.

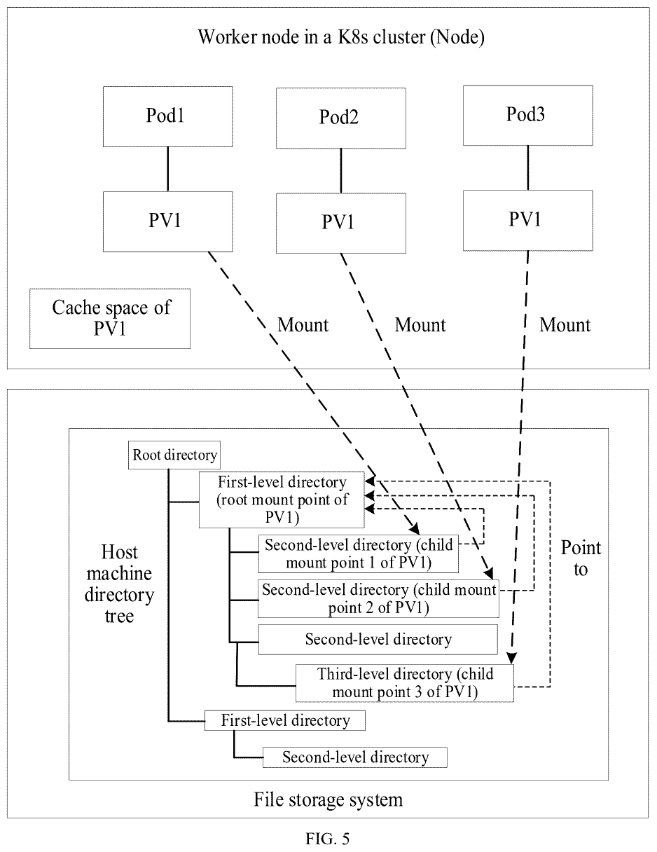

In view of the foregoing problem, according to the embodiments of the present application, a new mounting solution may be provided for the PV, that is, mounting to the PV is performed in a sub-tree mounting manner. Specifically, referring to FIG. 5, for example, in a working node (Node) in a K8s cluster, one or more pods may be deployed on the Node. In FIG. 5, for example, three different pods, namely, a Pod1, a Pod2, and a Pod3, are deployed on the Node, and the three pods need to be bound through a PV. It is assumed that a persistent volume jointly bound to the three pods is PV1.

Before the Pod1 accesses the PV1, first, mounting of the PV1 needs to be performed according to the following steps: querying, according to a name of the PV1, whether a root mount point of the PV1 exists in a mount list maintained by an operating system; if the root mount point of the PV1 does not exist in the mount list, creating a root mount point of the PV1 on the host machine directory tree, on one hand, associatively storing the root mount point of the PV1 and the name of the PV1 in the mount list, and on the other hand, determining, for the PV1, a child mount point 1 that points to the root mount point of the PV1 on the host machine directory tree, mounting the PV1 to the child mount point 1 of the host machine directory tree, and binding the root mount point of the PV1 to cache space; and if the root mount point of the PV1 exists in the mount list, directly determining, for the PV1, a child mount point 1 that points to the root mount point of the PV1 on the host machine directory tree, and mounting the PV1 to the child mount point 1 of the host machine directory tree. Similarly, before the Pod2 or the Pod3 accesses the PV1, mounting of the PV1 needs to be performed in a sub-tree mounting manner according to the foregoing procedure.

In FIG. 5, for example, the root mount point of the PV1 is a first-level directory, and for Pod1, a child mount point of PV1 is a second-level directory. For the Pod2, a child mount point of the PV1 is another second-level directory. For the Pod3, for example, a child mount point of the PV1 is a third-level directory, and three child mount points all point to a root mount point.

Regardless of which pod, after mounting of the pod onto the PV1 is completed, when the pod initiates an access operation on the PV1, the cache space bound to the root mount point of the PV1 is preferentially accessed, and when the cache space of the PV1 does not include data needed by the access operation, the PV1 is accessed according to the root mount point and the corresponding child mount point.

It should be noted that the host machine directory tree in FIG. 5 is a directory tree of a file storage system to which the working node mounted.

For each mounting operation for the PV1, because a child mount point needs to be created for the PV1, the operating system can sense the child mount point. In this way, it is convenient for the operating system to collect statistics on system-level information for the PV1, for example, collecting statistics on information such as how many times of mounting is performed for the PV1 and which pod initiates the mounting for the PV1 each time. Further, a daemon may be deployed on the working node, and the daemon is started when a first mounting operation is performed for the PV1. The daemon monitors a mounting operation for the PV1. When it is monitored that a root mount point is created for the PV1, a quantity of cited times of the root mount point is initialized to be 0, and each time it is monitored that a child mount point that points to the root mount point is added for the PV1, the quantity of cited times of the root mount point is increased by 1. In addition, when it is monitored that a pod (for example, the Pod1) bound to the PV1 is destructed from the Node, a child mount point corresponding to the destructed Pod is deleted from the host machine directory tree, and the number of cited times of the root mount point is reduced by 1. If the daemon detects that the quantity of cited times of the root mount point changes to 0 again, the daemon prompts the operating system that the root mount point can be uninstalled from the host machine directory tree.

In this embodiment, the PV bound to the pod is mounted in a sub-tree mounting manner. First, the pod can access the PV by using the root mount point on the host machine directory tree, so that the pod can use, by means of the PV, the storage system of the host machine as a storage facility for data sharing and persistence. Further, when a plurality of pods are bound to a same PV, the plurality of pods share a same cache resource (including data, metadata, a directory item, and the like) by using a root mount point in a manner of mounting a PV by using a sub-tree, so as to save memory resources of the host machine and improve the resource utilization rate of the host machine. In addition, mounting the PV by using a sub-tree pertains to a mounting operation natively supported by the operating system. By means of sub-tree mounting, when a same PV is bound to a plurality of pods, not only some pods are supported to be mounted in a read-write manner, but also some pods are supported to be mounted in a read-only manner. This has a relatively good flexibility in terms of mounting permission control. In addition, for mounting the PV by using a sub-tree, each mounting for the PV can be sensed by the operating system. Therefore, statistics about various system-level information may be collected for the PV, for example, a quantity of mounting times for which the PV is mounted, which pods are bound to the PV, and an occupation state of magnetic disc space during each mounting, thereby facilitating the management and maintenance of the mounting of the PV.

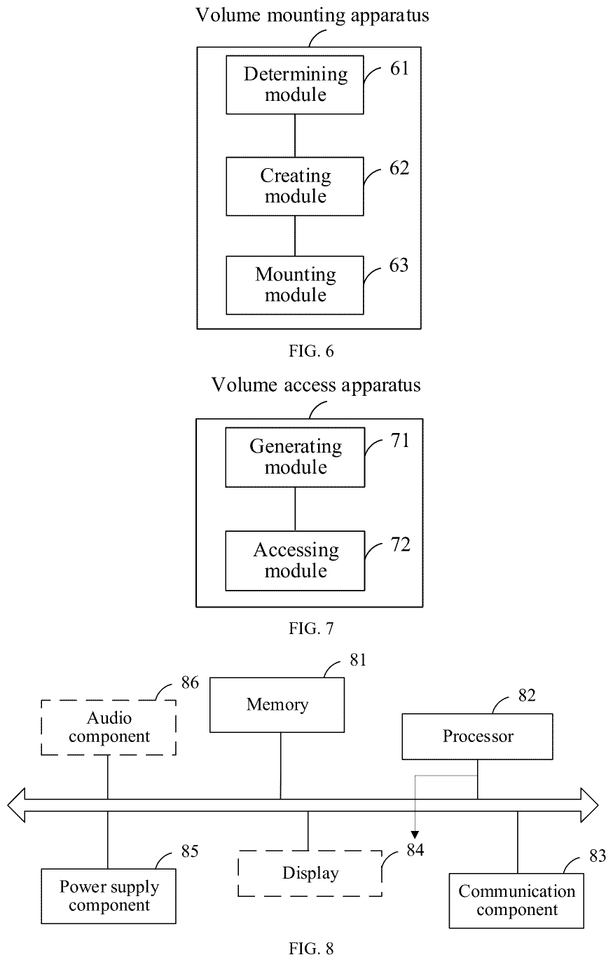

FIG. 6 is a schematic structural diagram of a volume mounting apparatus according to an embodiment of the present application. Referring to FIG. 6, the apparatus may include: a determining module 61, configured to determine a target volume that is bound to a target application instance and that is to be mounted to a host machine directory tree, where the host machine directory tree is a directory tree of a host machine where the target application instance is located; a creating module 62, configured to: if the host machine directory tree includes a root mount point of the target volume, create a child mount point that points to the root mount point on the host machine directory tree for the target application instance; and a mounting module 63, configured to mount the target volume to the root mount point in a sub-tree mounting manner based on the child mount point, so that the target application instance accesses the target volume through the root mount point.

Further, in an embodiment, the creating module 62 is further configured to: if the host machine directory tree does not include the root mount point of the target volume, before creating the child mount point, create the root mount point of the target volume on the host machine directory tree.

Further, in an embodiment, the target volume is capable of being bound to a plurality of application instances on the host machine, and the plurality of application instances include the target application instance.

Further, in an embodiment, the apparatus further includes a matching module, configured to: perform matching in a mount list corresponding to the host machine directory tree according to an identifier of the target volume, where the mount list records a mapping relationship between a volume that is already mounted to the host machine directory tree and a root mount point; if the identifier of the target volume is found through matching, use the root mount point corresponding to the identifier of the target volume as the root mount point of the target volume; and if the identifier of the target volume is not found through matching, determine that the host machine directory tree does not include the root mount point of the target volume.

Further, in an embodiment, when creating a child mount point that points to the root mount point on the host machine directory tree for the target application instance, the creating module 62 is specifically configured to: obtain, from a configuration file corresponding to the target application instance, a directory location that is on the host machine directory tree and is corresponding to the target application instance; and use the directory location as the child mount point, and establish a pointing relationship between the child mount point and the root mount point.

Further, in an embodiment, when establishing a pointing relationship between the child mount point and the root mount point, the creating module 62 is specifically configured to: use the root mount point as a parent mount point of the child mount point, and record an identifier of the root mount point in attribute information of the child mount point.

Further, in an embodiment, the mounting module 63 is further configured to increase a quantity of cited times of the root mount point according to a set quantity-of-times update step size, where the quantity-of-times update step size is a positive integer.

Further, in an embodiment, the mounting module 63 is further configured to: in a case that the target application instance is destructed from the host machine, reduce the quantity of cited times of the root mount point according to the quantity-of-times update step size; and in a case that the quantity of cited times of the root mount point is a preset initial value, uninstall the root mount point from the host machine directory tree.

Further, in an embodiment, the apparatus further includes an accessing module, configured to: in response to an access operation of the target application instance on the target volume, generate an access path of the target volume according to the root mount point and the child mount point of the target volume on the host machine directory tree; and perform an access operation of a corresponding type on the target volume according to the access path.

Further, in an embodiment, the creating module 62 is further configured to allocate cache space to the target volume according to the root mount point of the target volume, and bind the cache space of the target volume to the root mount point of the target volume. Based on this, the accessing module is specifically configured to: in response to an access operation of the target application instance on the target volume, determine the cache space of the target volume that is bound to the root mount point of the target volume; access the cache space of the target volume; if the cache space of the target volume does not include data needed by the access operation, generate an access path of the target volume according to the root mount point and the child mount point of the target volume on the host machine directory tree; and perform an access operation of a corresponding type on the target volume according to the access path.

The apparatus shown in FIG. 6 may perform the methods shown in FIG. 1 to FIG. 3, and the implementation principles and technical effects thereof are not further described. Specific manners of performing operations by modules and units of the apparatus shown in FIG. 6 in the foregoing embodiments have been described in detail in the embodiments related to the method, and details are not described in detail herein.

FIG. 7 is a schematic structural diagram of a volume access apparatus according to an embodiment of the present application. Referring to FIG. 7, the apparatus may include: a generating module 71, configured to: in response to an access operation of a target application instance on a target volume, generate an access path of the target volume according to a root mount point and a child mount point of the target volume on a host machine directory tree; and an accessing module 72, configured to perform an access operation of a corresponding type on the target volume according to the access path, where the target volume is a volume that is bound to the target application instance and that is mounted to the host machine directory tree.

Further, in an embodiment, the apparatus further includes: a determining module, configured to: before the generating module 71 generates the access path, determine cache space of the target volume bound to the root mount point of the target volume. Based on this, the accessing module 72 is further configured to: access the cache space of the target volume; if the cache space of the target volume does not include data needed by the access operation, perform the step of generating the access path of the target volume; and in a case that the data needed by the access operation exists in the cache space of the target volume, obtain the data needed by the access operation directly from the cache space of the target volume.

The apparatus shown in FIG. 7 may perform the method shown in FIG. 4, and the implementation principles and technical effects thereof are not further described. Specific manners of performing operations by modules and units of the apparatus shown in FIG. 7 in the foregoing embodiments have been described in detail in the embodiments related to the method, and details are not described in detail herein.

It is to be noted that, some processes described in the foregoing embodiments and accompanying drawings include a plurality of operations that appear in a particular sequence. However, it should be clearly understood that these operations may not be performed in the sequence in which the operations appear in this specification or may be performed in parallel. Sequence numbers of the operations, such as 401 and 402, are merely used for distinguishing different operations, and the sequence numbers do not indicate any execution sequence. In addition, the procedures may include more or fewer operations, and these operations may be performed in sequence or in parallel. It is to be noted that, the descriptions such as “first” and “second” in this specification are used to distinguish different messages, devices, modules, or the like, do not indicate a sequence, and do not limit that the “first” and “second” are of different types.

It is to be noted that, user information (including, but not limited to, user equipment information, user personal information, or the like) and data (including, but not limited to, data for analysis, stored data, displayed data, or the like) involved in the present application are all information and data authorized by the user or fully authorized by all parties, and the collection, use, and processing of related data need to comply with relevant laws, regulations, and standards of relevant countries and regions; and a corresponding operation entry is provided for the user to select to authorize or reject.

FIG. 8 is a schematic structural diagram of a computer device according to an embodiment of the present application. As shown in FIG. 8, the computer device includes: a memory 81 and a processor 82.

The memory 81 is configured to store a computer program, and may be configured to store various types of data, to support operations on the computer device. Examples of the data include an instruction, a message, a picture, a video, and the like of any application program or method operated on the computer device.

The memory 81 may be implemented by any type of volatile or non-volatile storage device or a combination thereof, such as a static random-access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk, or an optical disc.

The processor 82, coupled to the memory 81, is configured to execute the computer program in the memory 81, to implement the steps in the volume mounting method and/or the volume access method provided in the embodiments of the present application.

In some embodiments, the processor 82 executes the computer program in the memory 81, to: determine a target volume that is bound to a target application instance and that is to be mounted to a host machine directory tree, where the host machine directory tree is a directory tree of a host machine where the target application instance is located; determine whether the host machine directory tree includes a root mount point of the target volume; and if a determining result is yes, that is, the host machine directory tree includes the root mount point of the target volume, for the target application instance, create a child mount point that points to the root mount point on the host machine directory tree, and mount the target volume to the root mount point based on the child mount point in a sub-tree mounting manner, so that the target application instance accesses the target volume through the root mount point.

Further, in an embodiment, if a determining result is no, that is, the host machine directory tree does not include the root mount point of the target volume, create the root mount point of the target volume on the host machine directory tree, and for the target application instance, create the child mount point that points to the root mount point on the host machine directory tree, and mount the target volume to the root mount point based on the child mount point in a sub-tree mounting manner, so that the target application instance accesses the target volume through the root mount point.

In an embodiment, the target volume is capable of being bound to a plurality of application instances on the host machine, and the plurality of application instances include the target application instance.

In an embodiment, the processor 82 is further configured to: perform matching in a mount list corresponding to the host machine directory tree according to an identifier of the target volume, where the mount list records a mapping relationship between a volume that is already mounted to the host machine directory tree and a root mount point; if the identifier of the target volume is found through matching, use the root mount point corresponding to the identifier of the target volume as the root mount point of the target volume; and if the identifier of the target volume is not found through matching, determine that the host machine directory tree does not include the root mount point of the target volume.

In an embodiment, when creating, for the target application instance, a child mount point pointing to the root mount point on the host machine directory tree, the processor 82 is specifically configured to: obtain, from a configuration file corresponding to the target application instance, a directory location that is on the host machine directory tree and is corresponding to the target application instance; and use the directory location as the child mount point, and establish a pointing relationship between the child mount point and the root mount point.

In an embodiment, when establishing a pointing relationship between the child mount point and the root mount point, the processor 82 is specifically configured to: use the root mount point as a parent mount point of the child mount point, and record an identifier of the root mount point in attribute information of the child mount point.

In an embodiment, after mounting the target volume to the root mount point in a sub-tree mounting manner based on the child mount point, the processor 82 is further configured to: increase a quantity of cited times of the root mount point according to a set quantity-of-times update step size, where the quantity-of-times update step size is a positive integer.

In an embodiment, the processor 82 is further configured to: in a case that the target application instance is destructed from the host machine, reduce the quantity of cited times of the root mount point according to the quantity-of-times update step size; and in a case that the quantity of cited times of the root mount point is a preset initial value, uninstall the root mount point from the host machine directory tree.

In an embodiment, the processor 82 is further configured to: in response to an access operation of the target application instance on the target volume, generate an access path of the target volume according to the root mount point and the child mount point of the target volume on the host machine directory tree; and perform an access operation of a corresponding type on the target volume according to the access path.

In an embodiment, the processor 82 is further configured to: allocate cache space for the target volume according to the root mount point of the target volume, and bind the cache space of the target volume to the root mount point of the target volume.

In an embodiment, the processor 82 is specifically configured to: in response to an access operation of the target application instance on the target volume, determine cache space of the target volume that is bound to the root mount point of the target volume; if the cache space of the target volume does not include data needed by the access operation, generate an access path of the target volume according to the root mount point and the child mount point of the target volume on the host machine directory tree; and perform an access operation of a corresponding type on the target volume according to the access path.

In some embodiments, the processor 82 executes the computer program in the memory 81, to: in response to an access operation of a target application instance on a target volume, generate an access path of the target volume according to a root mount point and a child mount point of the target volume on a host machine directory tree; and perform an access operation of a corresponding type on the target volume according to the access path, where the target volume is a volume that is bound to the target application instance and that is mounted to the host machine directory tree.

In an embodiment, before generating an access path of the target volume, the processor 82 is further configured to: determine cache space of the target volume that is bound to the root mount point of the target volume; and if the cache space of the target volume does not include data needed by the access operation, perform the step of generating the access path of the target volume.

For the steps in the methods, refer to the foregoing embodiments, and details are not described herein again.

Further, as shown in FIG. 8, the computer device further includes: other components such as a communication component 83, a display 84, a power supply component 85, and an audio component 86. Only some components are schematically provided in FIG. 8, which does not mean that the computer device includes only the components shown in FIG. 8. In addition, the components in the dashed-line boxes in FIG. 8 are optional components rather than mandatory components, and may be specifically determined according to a product form of the computer device. The computer device in this embodiment may be implemented as a terminal device such as a desktop computer, a laptop, a smartphone, or an IOT (Internet of things) device, or may be a server device such as a conventional server, a cloud server, or a server array. If the computer device in this embodiment is implemented as a terminal device such as a desktop computer, a laptop, or a smartphone, the computer device may include the components in the dashed-line boxes in FIG. 8. If the computer device in this embodiment is implemented as a server device such as a conventional server, a cloud server, or a server array, the computer device may not include the components in the dashed-line boxes in FIG. 8.

For a detailed implementation process of the actions performed by the processor, refer to related descriptions in the foregoing method embodiment or device embodiment, and details are not described herein again.

Correspondingly, an embodiment of the present application further provides a computer readable storage medium storing a computer program. When the computer program is executed, the steps in the volume mounting method and/or the volume access method provided in the embodiments of the present application are implemented.

Correspondingly, an embodiment of the present application further provides a computer program product, including a computer program/instruction. The computer program/instruction, when executed by a processor, causes the processor to implement the steps in the volume mounting method and/or the volume access method provided in the embodiments of the present application.

The communication component is configured to facilitate communication in a wired or wireless manner between a device where the communication component is located and another device. The device where the communication component is located may access a wireless network based on a communication standard, for example, a mobile communication network such as WiFi (Wireless Fidelity), 2G (the second Generation), 3G (the third Generation), 4G (the fourth Generation)/LTE (long Term Evolution), or 5G (the fifth Generation), or a combination thereof. In an exemplary embodiment, the communication component receives a broadcast signal or broadcast related information from an external broadcast management system through a broadcast channel. In an exemplary embodiment, the communication component further includes a Near Field Communication (NFC) module, to facilitate short-range communication. For example, the NFC module may be implemented based on the Radio Frequency Identification (RFID) technology, the Infrared Data Association (IrDA) technology, the Ultra Wide Band (UWB) technology, the Bluetooth (BT) technology, and other technologies.

The display includes a screen, and the screen may include a liquid crystal display (LCD) and a touch panel (TP). If the screen includes the touch panel, the screen may be implemented as a touchscreen, to receive an input signal from a user. The touch panel includes one or more touch sensors to sense a touch, a slide, and a gesture on the touch panel. The touch sensor not only can sense a boundary of a touch or slide operation, but also can detect duration and pressure related to the touch or slide operation.

The power supply component provides power to various components of a device where the power supply component is located. The power supply component may include a power supply management system, one or a plurality of power supplies, and other components associated with generating, managing, and allocating power for a device in which the power supply component is located.

The audio component may be configured to output and/or input an audio signal. For example, the audio component includes a microphone (MIC). When a device where the audio component is located is in an operation mode, such as a calling mode, a recording mode, and a speech recognition mode, and the microphone is configured to receive an external audio signal. The received audio signal may be further stored in a memory or sent by using a communication component. In some embodiments, the audio component further includes a speaker, configured to output an audio signal.

A person skilled in the art can understand that the embodiments of the present application may be provided as a method, a system, or a computer program product. Therefore, the present application may use a form of hardware-only embodiments, software-only embodiments, or embodiments combining software and hardware. Moreover, the present application may use a form of a computer program product implemented on one or more computer-readable storage media (including, but not limited to, a disk storage device, a CD-ROM, an optical memory, or the like) including computer-usable program code.

The present application is described with reference to flowcharts and/or block diagrams of the method, the device (system), and the computer program product according to the embodiments of the present application. It should be understood that computer program instructions can implement each procedure and/or block in the flowcharts and/or block diagrams and a combination of procedures and/or blocks in the flowcharts and/or block diagrams. These computer program instructions may be provided to a general-purpose computer, a special-purpose computer, an embedded processor, or a processor of another programmable data processing device to generate a machine, so that an apparatus configured to implement functions specified in one or more procedures in the flowcharts and/or one or more blocks in the block diagrams is generated by using instructions executed by the computer or the processor of another programmable data processing device.

These computer program instructions may alternatively be stored in a computer-readable memory that can instruct a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

These computer program instructions may further be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, the computing device includes one or a plurality of central processing units (CPU), an input/output interface, a network interface, and a memory.

The memory may include a non-persistent memory in a computer-readable medium, a random access memory (RAM) and/or a non-volatile memory, such as a read only memory (ROM) or a flash RAM. The memory is an example of the computer-readable medium.

The computer-readable medium includes a non-volatile medium and a volatile medium, a removable medium and a non-removable medium, which may implement storage of information by using any method or technology. The information may be a computer-readable instruction, a data structure, a program module, or other data. Examples of the storage medium for a computer include, but are not limited to, a phase change memory (Phase Change RAM, PRAM), a static random access memory (SRAM), a dynamic random access memory (DRAM), other types of random access memory (RAM), a read only memory (ROM), an electrically erasable programmable read-only memory (EEPROM), or a flash memory, or other memory technique, a compact disc read-only memory (CD-ROM), digital video disc (DVD), or other optical storage, magnetic cartridges, magnetic disk storage, or other magnetic storage devices, or any other non-transmission medium that can be used to store information that can be accessed by a computing device. As defined herein, the computer-readable medium does not include transitory media, such as a modulated data signal and a carrier wave.

It should be further noted that the terms “comprise”, “include”, or any other variant thereof are intended to encompass non-exclusive inclusions such that a process, method, commodity, or device including a series of elements includes not only those elements, but also other elements not explicitly listed, or also includes elements inherent to such process, method, commodity, or device. Unless otherwise specified, an element limited by “include a/an ... ” does not exclude other same elements existing in the process, the method, the commodity, or the device that includes the element.

The foregoing descriptions are only embodiments of the present application and are do not intended to limit the present application. For a person skilled in the art, various modifications and variations can be made to the present application. Any modification, equivalent replacement, or improvement made without departing from the spirit and principle of the present application shall fall within the scope of the claims of the present application.

1. A volume mounting method, comprising:
determining a target volume that is bound to a target application instance and that is to be mounted to a host machine directory tree, wherein the host machine directory tree is a directory tree of a host machine where the target application instance is located;
when the host machine directory tree comprises a root mount point of the target volume, creating a child mount point that points to the root mount point on the host machine directory tree for the target application instance; and
mounting the target volume to the root mount point in a sub-tree mounting manner based on the child mount point, so that the target application instance accesses the target volume through the root mount point.

2. The method according to claim 1, further comprising:
when the host machine directory tree does not comprise the root mount point of the target volume, before creating the child mount point, creating the root mount point of the target volume on the host machine directory tree.

3. The method according to claim 1, wherein the target volume is capable of being bound to a plurality of application instances on the host machine, and the plurality of application instances comprise the target application instance.

4. The method according to claim 1, further comprising:
performing matching in a mount list corresponding to the host machine directory tree according to an identifier of the target volume, wherein the mount list records a mapping relationship between a volume that is already mounted to the host machine directory tree and a root mount point; and
when the identifier of the target volume is found through matching, using the root mount point corresponding to the identifier of the target volume as the root mount point of the target volume; and
when the identifier of the target volume is not found through matching, determining that the host machine directory tree does not comprise the root mount point of the target volume.

5. The method according to claim 1, wherein the creating a child mount point that points to the root mount point on the host machine directory tree for the target application instance comprises:
obtaining, from a configuration file corresponding to the target application instance, a directory location that is on the host machine directory tree and is corresponding to the target application instance; and
using the directory location as the child mount point, and establishing a pointing relationship between the child mount point and the root mount point.

6. The method according to claim 5, wherein the establishing a pointing relationship between the child mount point and the root mount point comprises:
using the root mount point as a parent mount point of the child mount point, and recording an identifier of the root mount point in attribute information of the child mount point.

7. The method according to claim 1, wherein after the mounting the target volume to the root mount point in a sub-tree mounting manner based on the child mount point, the method further comprises:
increasing a quantity of cited times of the root mount point according to a set quantity-of-times update step size, wherein the quantity-of-times update step size is a positive integer.

8. The method according to claim 7, further comprising:
in a case that the target application instance is destructed from the host machine, reducing the quantity of cited times of the root mount point according to the quantity-of-times update step size; and
in a case that the quantity of cited times of the root mount point is a preset initial value, uninstalling the root mount point from the host machine directory tree.

9. The method according to claim 2, further comprising:
allocating cache space to the target volume according to the root mount point of the target volume, and binding the cache space of the target volume to the root mount point of the target volume.

10. The method according to claim 9, further comprising:
in response to an access operation of the target application instance on the target volume, determining the cache space of the target volume that is bound to the root mount point of the target volume;
when the cache space of the target volume does not comprise data needed by the access operation, generating an access path of the target volume according to the root mount point and the child mount point of the target volume on the host machine directory tree; and
performing an access operation of a corresponding type on the target volume according to the access path.

11. A volume access method, comprising:
in response to an access operation of a target application instance on a target volume, generating an access path of the target volume according to a root mount point and a child mount point of the target volume on a host machine directory tree; and
performing an access operation of a corresponding type on the target volume according to the access path, wherein the target volume is a volume that is bound to the target application instance and that is mounted to the host machine directory tree.

12. The method according to claim 11, wherein before the generating an access path of the target volume, the method further comprises:
determining cache space of the target volume that is bound to the root mount point of the target volume;
when the cache space of the target volume does not comprise data needed by the access operation, performing the step of generating the access path of the target volume.

13. A computer device, comprising: a memory and a processor, the memory being configured to store a computer program; the processor is coupled to the memory and configured to:
determine a target volume that is bound to a target application instance and that is to be mounted to a host machine directory tree, wherein the host machine directory tree is a directory tree of a host machine where the target application instance is located;
when the host machine directory tree comprises a root mount point of the target volume, create a child mount point that points to the root mount point on the host machine directory tree for the target application instance; and
mount the target volume to the root mount point in a sub-tree mounting manner based on the child mount point, so that the target application instance accesses the target volume through the root mount point.

14. A non-transitory computer readable storage medium storing a computer program, wherein the computer program, when executed by a processor, causes the processor to implement steps in the method according to claim 1.

15. The computer device according to claim 13, wherein the processor is further configured to:
when the host machine directory tree does not comprise the root mount point of the target volume, before creating the child mount point, create the root mount point of the target volume on the host machine directory tree.

16. The computer device according to claim 13, wherein the target volume is capable of being bound to a plurality of application instances on the host machine, and the plurality of application instances comprise the target application instance.

17. The computer device according to claim 13, wherein the processor is further configured to:
perform matching in a mount list corresponding to the host machine directory tree according to an identifier of the target volume, wherein the mount list records a mapping relationship between a volume that is already mounted to the host machine directory tree and a root mount point; and
when the identifier of the target volume is found through matching, use the root mount point corresponding to the identifier of the target volume as the root mount point of the target volume; and
when the identifier of the target volume is not found through matching, determine that the host machine directory tree does not comprise the root mount point of the target volume.

18. The computer device according to claim 13, wherein the processor is specifically configured to:
obtain, from a configuration file corresponding to the target application instance, a directory location that is on the host machine directory tree and is corresponding to the target application instance; and
use the directory location as the child mount point, and establish a pointing relationship between the child mount point and the root mount point.

19. A computer device, comprising: a memory and a processor, the memory being configured to store a computer program; the processor is coupled to the memory and configured to execute the computer program to perform the steps in the method according to claim 11.

20. A non-transitory computer readable storage medium storing a computer program, wherein the computer program, when executed by a processor, causes the processor to implement steps in the method according to claim 11.
